(19) United States
(12) Patent Application Publication
(10) Pub. No.: US 2023/0023336 A1
(43) Pub. Date: Jan. 26, 2023

(54) EDIBLE STRAW AND METHOD FOR MANUFACTURING THE SAME

(71) Applicant: PAN AKIMOTO CO., LTD., Nasushiobara-shi (JP)

(72) Inventor: Yoshihiko AKIMOTO, Nasushiobara-shi (JP)

(21) Appl. No.: 17/384,059

(22) Filed: Jul. 23, 2021

(51) Int. Cl. A23P 20/25; A47G 21/18; A23L 7/10

(52) U.S. Cl. CPC A23P 20/25; A47G 21/18; A23L 7/10; A23V 2002/00

(57) ABSTRACT

Provided is an edible straw that can have an improved durability in use and during transportation. A method for manufacturing an edible straw S includes: applying an edible adhesive F on at least one surface of an edible item sheet 100 shaped into a sheet and made, as an edible item, of cereals such as rice and wheat or other starch materials; forming the edible item sheet 100 on which the adhesive F is applied into a tubular shape with a space through which beverages and the like are to be passed, and heating and baking the tubular body from at least one of an inner wall side and an outer wall side of the tubular body.

### BACKGROUND OF THE INVENTION

### Field of the Invention

The present invention relates to a technique for manufacturing a drinking straw made of an edible item.

### Description of the Related Art

Recently, resin and plastic products have been drawing attention as environmental contaminants, and accordingly, entities such as business companies have been studying restrictions on the use of drinking straws among socially problematic plastic products.

Given such a problem, for example, a straw disclosed in Japanese Utility Model Laid-Open No. 61-69985 is produced by forming a tubular body from an edible item, and forming a water resistant edible film at least on an inner surface of the tubular body.

Japanese Utility Model Laid-Open No. 61-186385 discloses a chocolate straw in which chocolate is used as one kind of edible items. A plurality of rolled spaces are formed in the chocolate straw.

### BRIEF SUMMARY OF THE INVENTION

However, a remaining problem with the prior art edible straws is durability in use and during transportation. Specifically, for example, a problem is that beverages and the like passing through the straw have various temperature and viscosity, which leads to an increase in costs to accommodate the variations, such as by thickening the edible film or increasing the thickness of the chocolate. Further, another problem with such edible straws is that the straw is more “fragile” and “breakable” relative to a plastic straw, and accordingly requires considerable attention in manufacturing and during transportation for delivery, leading to an increase in costs.

A principal object of the present invention is to provide an edible straw that can have an improved durability in use and during transportation. A method for manufacturing the edible straw is also provided.

The present invention provides a method for manufacturing an edible straw, including: applying an edible adhesive on at least one surface of a rice paper to soften the rice paper; forming the rice paper on which the adhesive is applied into a tubular body such that the adhesive is present between overlapped portions of the rice paper; and heating the tubular body from at least one of an inner wall side and an outer wall side of the tubular body to allow a water content of the adhesive to evaporate.

In the edible straw of the present invention, a space surrounded by the inner wall of a tubular body is filled with powder, the tubular body being of an edible item sheet shaped into a sheet and formed in a tubular shape.

According to the present invention, an edible straw that can have an improved durability in use and during transportation can be provided. A method for manufacturing the edible straw can also be provided.

### BRIEF DESCRIPTION OF SEVERAL VIEWS OF THE DRAWINGS

FIG. 1 is a schematic for illustrating an example of a configuration of an edible straw according to an embodiment;

FIG. 2 illustrates views (a), (b), and (c) for illustrating an example of a manufacturing process of the edible straw;

FIG. 3 illustrates views (a) and (b) for illustrating an example of a manufacturing process of an edible straw different from FIG. 2;

FIG. 4 illustrates views (a), (b), and (c) for illustrating a state in which a space surrounded by the inner wall of a tubular body, which is of an edible item sheet formed in a tubular shape, is filled with powder;

FIG. 5 illustrates views (a) and (b) for illustrating another example of wrapping an edible item sheet around a mandrel; and

FIG. 6 illustrates views (a) and (b) for illustrating edible straws contained in a container box.

### DETAILED DESCRIPTION OF THE INVENTION

Embodiments will now be described with reference to drawings. For edible straws according to embodiments, description will be made as to drinking straws as examples in which an edible item sheet made, as an edible item, of cereals such as rice and wheat or other starch materials, for example, a rice paper, is used. Any edible item sheets made of other raw materials such as vegetables and seaweed may be used as the edible item.

### EXEMPLARY EMBODIMENTS

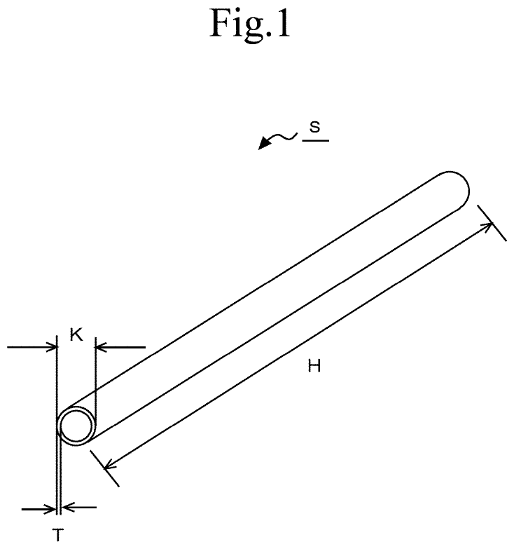

FIG. 1 is a schematic for illustrating an example of a configuration of an edible straw according to the embodiment.

An edible straw S illustrated in FIG. 1 is a straw formed in a tubular shape with a space through which beverages and the like are to be passed. The edible straw S illustrated in FIG. 1 is an edible straw that has a length H, an outer diameter K, and a thickness T (a thickness of a wall).

For example, when dimensions of an inner wall-side space of a tubular body (a straw body) of an edible item sheet 100 formed in a tubular shape are 5 [mm] of diameter and 1 [mm] of the thickness T of the wall, the tubular body can be formed, for example, with 7 [mm] of the outer diameter K and 200 [mm] of the length H. These dimensions may be designed as necessary depending on temperature, viscosity, and the like of beverages and the like of interest.

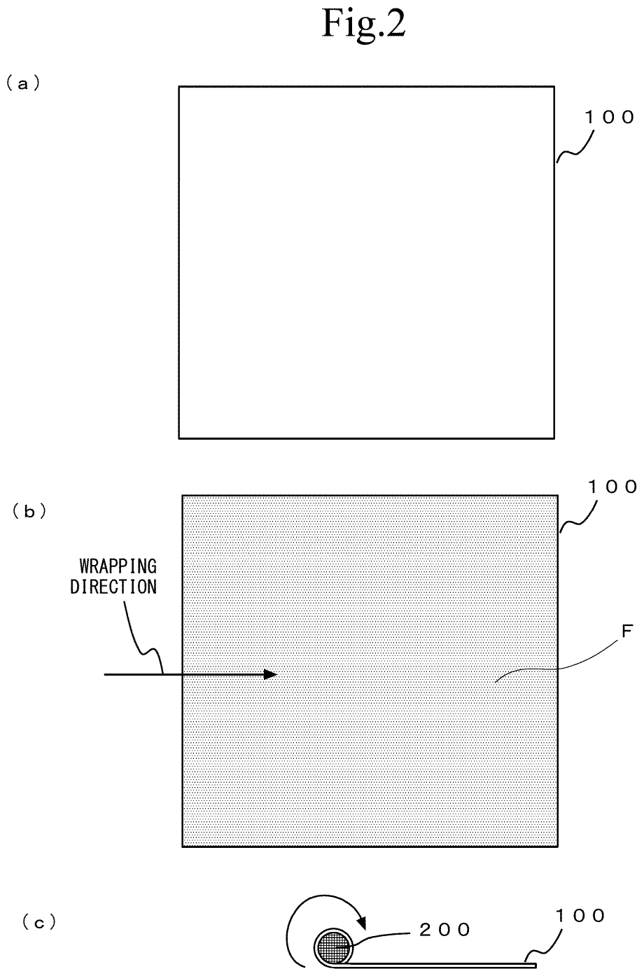

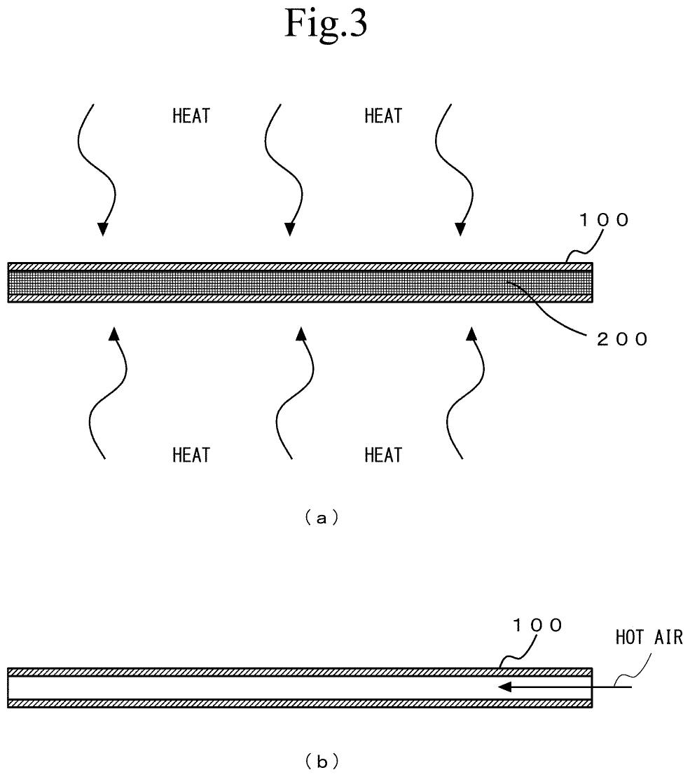

FIGS. 2 and 3 are schematics for illustrating examples of a manufacturing process of the edible straw S.

FIG. 2 (a) illustrates an example of the edible item sheet 100, FIG. 2 (b) illustrates a surface of the edible item sheet 100 on which adhesive F is applied, and FIG. 2 (c) illustrates how the edible item sheet 100 is to be formed in a tubular shape.

FIG. 3 (a) illustrates when the tubular body of the edible item sheet 100 formed in a tubular shape is heated and baked, and FIG. 3 (b) illustrates when the tubular body is heated and baked in a manner different from FIG. 3 (a).

An example of the edible item sheet illustrated in FIG. 2 (a) will now be described.

The edible item sheet 100 is formed by kneading rice powder, flour, soybeans, grain, or other starch materials with water (liquid) into a paste, and spreading the paste into a sheet shape and allowing it to dry. In this way, the edible item is in a so-called rice paper state. The edible item in this state is less bulky in storage and has a good shelf life because it is dried. For the purpose of improving taste or product strength, sugar, salt, or the like may be added.

With regard to the dimensions of the edible item sheet 100, assuming that an up-down direction as seen in front view of the figure is the height of the edible item sheet 100, for example, the length is a determinative element for the length H of the edible straw S after formation.

Further, assuming that a right-left direction as seen in front view of the figure is the width of the edible item sheet, the length is a determinative element for the thickness T (the thickness of a wall) and an outer diameter dimension of the edible straw wrapped around a mandrel 200 as described later.

An example of a step of forming the edible item sheet 100 illustrated in FIG. 2 (a) into a tubular shape will now be described.

The edible item in a sheet shape is not suitable for bending while it is in a dried state. Accordingly, as illustrated in FIG. 2 (b), an edible adhesive F such as edible glue containing water is applied on one surface or both surfaces of the edible item sheet by spreading lightly or spraying in a mist. In this way, the edible item sheet is softened, so that it can easily be wrapped around the mandrel 200 as described later.

The softening step may be omitted by keeping the edible item sheet in a semi-dried state.

The mandrel 200 illustrated in FIG. 2 (c) is a radiator formed in a cylindrical shape and is one kind of heater for heating and baking the tubular body, which is formed by wrapping the edible item sheet 100 around the mandrel 200, from an inner wall side.

Note that the outer diameter dimension of the mandrel 200 is the same as the diameter of the space through which beverages and the like are to be passed in the edible straw S after formation. The heater function may be implemented in such a manner that heat is generated by electrical conduction through a nichrome wire arranged within the mandrel 200, for example. For the purpose of facilitating taking out of the mandrel 200 from the tubular body (the straw body), the length of the mandrel 200 may be relatively longer than the length of the tubular body.

The temperature of heating and baking performed by the mandrel 200 is adjusted to on the order of a temperature at which, for example, the grain is solidified (for example, 65 [° C.]). For example, a corn starch gelatinization temperature is 64 [° C.] to 71 [° C.] and a sweet potato starch gelatinization temperature is 82 [° C.] to 83 [° C.]. In the edible straw baking step, the baking temperature may be determined not only for gelatinization, but also for texture, flavor, and pleasant taste of the material.

Any number of times of wrapping the softened edible item sheet 100 around the mandrel 200 (number of turns) may be set as necessary for the intended use of the edible straw S. Note that the number of turns is set to a number of turns such that at least when the edible straw S is used as a straw, liquid is prevented from leaking from a side surface of the straw.

For example, in the case of two or more of turns, the edible adhesive F is present between overlapped portions of the edible item sheet, so that the portions of the edible item sheet are securely bonded together by being heated and baked by the mandrel 200 to allow the water content to evaporate. Accordingly, the edible straw S formed in this way will be excellent in durability in use and during transportation.

Further, in the case in which the edible adhesive F is an edible glue containing water, the water content evaporates when heated and baked by the mandrel 200, so that the portions of the edible item sheet are securely bonded together, and a film is formed between the portions of the edible item sheet. Accordingly, the edible straw S in use can be more water resistant.

When the heating and baking is to be started or ended by the mandrel 200 is set as necessary depending on the number of turns of the edible item sheet 100, an applied quantity of the edible adhesive F (or the degree of dryness of the edible item sheet), the kind of the edible item itself or the kind of the adhesive F, and the like as described above.

An example of a step of heating and baking the tubular body of the edible item sheet 100 illustrated in FIG. 3 (a) formed in a tubular shape will now be described. How the tubular body is heated and baked from the inner wall side by the mandrel 200 is in a similar manner to the above description.

As illustrated in FIG. 3 (a), heat is also applied from the outer wall (the outer wall of the tubular body) side in a state in which the edible item sheet 100 is wrapped around the mandrel 200 (the tubular body) for heating and baking. In addition to heating and baking the tubular body from the inner wall side by the mandrel 200, the tubular body is heated and baked from the outer wall side by a separate heating feature (for example, an oven or a burner), so that the water content can efficiently be allowed to evaporate. As a result, it is possible to prevent the inner wall and the outer wall of the tubular body from being charred by heating.

For the purpose of efficient taking out of the mandrel 200 from the tubular body, in other words, for preventing what is called “sticking” between a surface of the mandrel 200 and the inner wall of the tubular body, for example, an appropriate amount of oil such as edible fat and oil may be applied on the surface of the mandrel 200.

As illustrated in FIG. 3 (b), the heating and baking the tubular body on the inner wall side may be arranged to allow the water content to evaporate by allowing hot air to pass through a cavity left after the mandrel 200 is pulled out from the tubular body. The manufacturing step is effective for heating and baking when a type of edible item sheet that makes it difficult to pull out the mandrel 200 when heated and baked by the mandrel 200 is used.

Although description has been made as to the case in which the tubular body (the straw body) is heated and baked from the inner wall side and the outer wall side respectively, it is not a limitation, and, for example, the tubular body may be heated and baked from at least one of the inner wall side and the outer wall of the tubular body depending on the kind of the edible item itself or the like.

For each of the case of heating and baking when heat is applied to the tubular body (the straw body) of the edible item sheet 100 formed in a tubular shape from the inner wall side and the case of heating and baking when heat is applied to the tubular body from the outer wall side, timing of starting or ending, the order of starting the heating and baking, or the like may be set as necessary depending on the number of turns of the edible item sheet 100, an applied quantity of the edible adhesive F (or the degree of dryness of the edible item sheet), the kind of the edible item itself, and the like as described above.

As described above, the method for manufacturing an edible straw according to the embodiments includes heating the tubular body from at least one of the inner wall side and the outer wall side of the tubular body during forming the straw body.

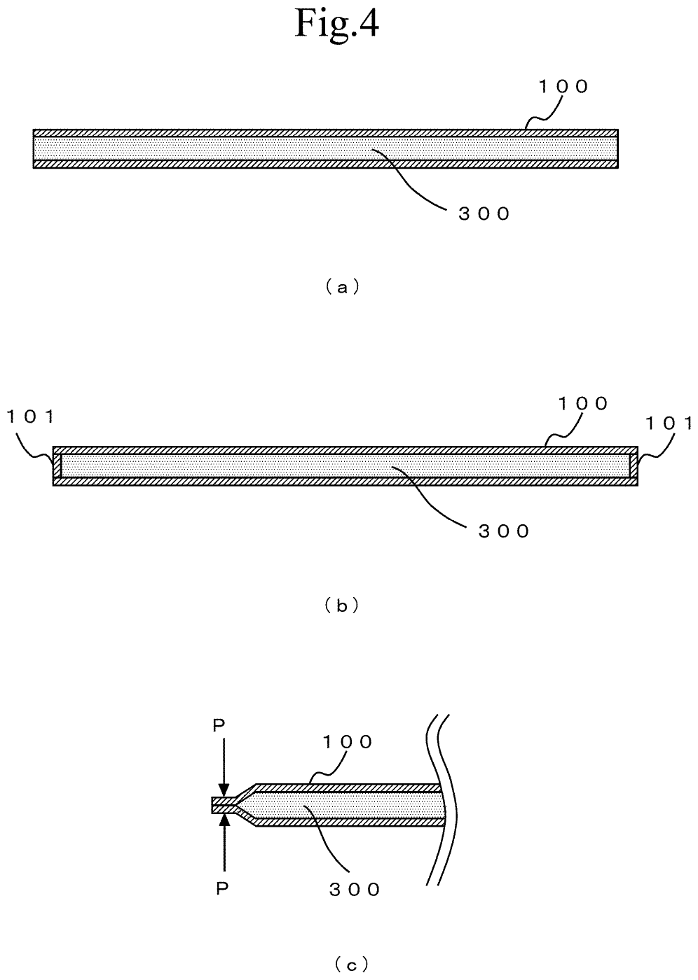

FIG. 4 illustrates a state in which a space surrounded by the inner wall of a tubular body, which is of an edible item sheet 100 formed in a tubular shape, is filled with powder.

FIG. 4 (a) illustrates the edible straw S filled with powder 300 in the space surrounded by the inner wall of the tubular body (the straw body), and FIG. 4 (b) illustrates the edible straw S filled with the powder 300 in the space surrounded by the inner wall of the tubular body with openings of the tubular body being sealed. FIG. 4 (c) illustrates an example of a different way of sealing the opening of the tubular body from that in FIG. 4 (b).

Note that the powder 300 for filling is, for example, of a material that causes no harm in the mouth of a user who uses the edible straw and includes powder, juice syrup, powdered milk, or the like suitable for drying. Any powder 300 for filling may be selected as necessary for the application of the edible straw.

The edible straw S illustrated in FIG. 4 (b) is formed by sealing one opening of the tubular body with a sealing member 101 to form a bottomed tubular body, feeding powder from an opening of the bottomed tubular body (the other opening of the tubular body), and thereafter sealing the opening of the bottomed tubular body with another sealing member 101.

For the sealing member 101 in this case, an edible item that has ingredients similar to those of the edible item sheet 100 or any other edible items may be used, for example.

Instead of sealing the opening of the tubular body with the sealing member 101, for example, as illustrated in FIG. 4 (c), the opening may be sealed by applying a pressure P to an end of the tubular body of the edible item sheet 100 formed in a tubular shape so that the opening is “collapsed”. In this case, an appropriate amount of water provided to the end of the tubular body before heating and pressurizing can help prevent damages on the end.

The manufacturing processes for an edible straw as described above may be implemented by predetermined devices. Operations of various components (such as, for example, an operation of the mandrel 200) and conditional settings (such as temperature control for heating and baking) used in a series of manufacturing processes for the edible straw S performed by such devices may be controlled by a control device, a computer, and the like included in the devices.

As described above, in the edible straw S according to the embodiments, the edible adhesive F is present between overlapped portions of the edible item sheet in the tubular body of the edible item sheet 100 formed in a tubular shape. Accordingly, it is possible to improve durability in use and during transportation as well as water resistant in use.

Further, since the cavity of the tubular body, which is the straw body, is filled with the powder 300, it is possible to prevent damages (those caused by externally applied pressure) while the edible straw S is being carried.

By thus heating and baking the inner wall surface and the outer wall surface, starch is made gelatinized and thereafter cooled to be hardened, so that the edible straw that is strong to some degree can be formed. Further, since the edible glue (the adhesive F) is applied on at least one surface of the inner wall surface and the outer wall surface, a film is left on the surface after baked and dried. As a result, it is possible to improve a moisture-resistant effect and strength of the straw body.

The tubular body as it is formed can be used as a straw. However, when there is an anticipated risk of deformation or collapse due to an external pressure, the tubular body is packed with various edible powder (such as juice syrup selected as necessary for the intended use). Accordingly, it is possible to increase the strength in storage, during transportation, and before use, and also to suggest various unique ways of use to a user depending on filled powder.

Note that the wrapping direction of the edible item sheet 100 around the mandrel 200 is not limited to that of the example in FIG. 2.

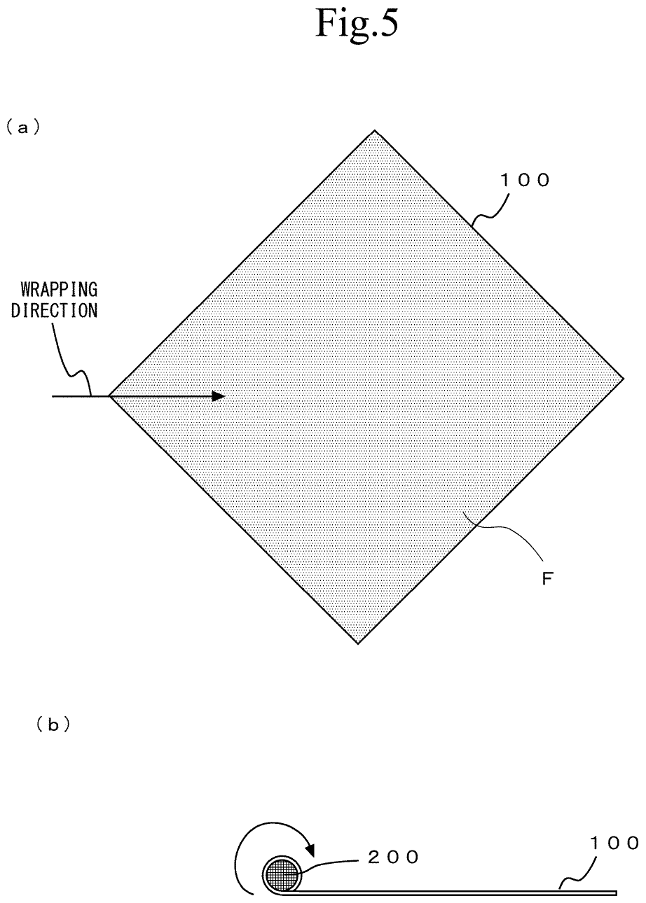

FIG. 5 illustrates another example of wrapping the edible item sheet 100 around the mandrel 200. As illustrated in (a) and (b) of FIG. 5, the mandrel 200 may be rotate in the direction of a diagonal line of the edible item sheet 100, which may be wrapped around the mandrel 200. In this case, after the mandrel 200 is taken out, the ends of the tubular body are left open in an angled manner. Accordingly, there may be an additional step of cutting or otherwise shaping the ends so that the openings become flat, as necessary.

The heating and baking of the tubular body on the inner wall side by the mandrel 200 and the heating and baking of the tubular body performed from the outer wall side may be performed in the following procedure.

First, the heating and baking of the tubular body on the inner wall side by the mandrel 200 is performed for a predetermined time. Next, heating and baking of the tubular body on the outer wall side is started.

With such manufacturing processes (a manufacturing method), the tubular body expands outward by being heated and baked by the mandrel 200 from the inner wall side of the tubular body, so that a space (a gap) is created between the surface of the mandrel 200 and the inner wall side of the tubular body. Accordingly, it is possible to effectively prevent what is called “sticking” between the surface of the mandrel 200 and the inner wall side of the tubular body.

Thereafter, by starting heating and baking of the tubular body on the outer wall side, the water content can effectively be allowed to evaporate.

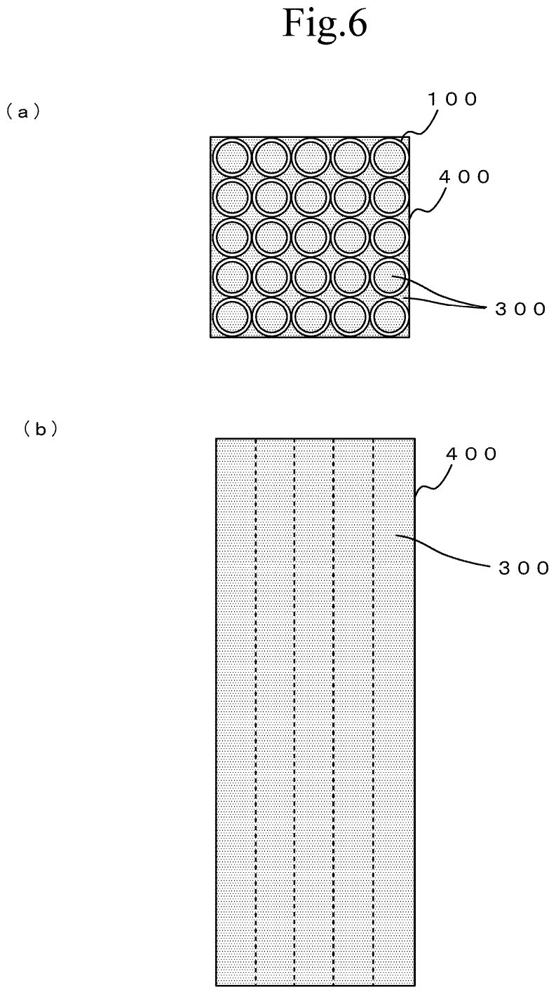

FIG. 6 illustrates views (a) and (b) for illustrating edible straws S contained in a container box 400. FIG. 6 (a) is a front view illustrating a state in which a specified number of the tubular bodies (the straw bodies) are contained in a container (a container box 400) configured to be capable of containing a plurality of the edible straws S, and FIG. 6 (b) is a side view.

The edible straws S illustrated in FIG. 6 have unsealed ends. Further, in FIG. 6, as an example, 25 tubular bodies (straw bodies: edible item sheets 100) are contained.

As illustrated in FIG. 6, the tubular bodies (the straw bodies: the edible item sheets 100) are contained in the container box 400, and thereafter, the inside of the container box and the tubular body inner wall-side space are filled with powder 300.

Specifically, the tubular bodies with the openings being left unsealed are contained in the container box 400, and the powder 300 is fed from the opening side of the tubular body to the inner wall space and the space formed by adjacent tubular bodies. In other words, a specified number of the tubular bodies are contained in a container (a container box 400) configured to be capable of containing a plurality of the edible straws S, and the space surrounded by the inner wall of each of the tubular bodies and any space in the container other than the space surrounded by the inner wall of each of the tubular bodies are filled with powder.

In this way, the step of sealing the end of the tubular body is omitted, while it is possible to more effectively prevent damages (those caused by externally applied pressure) while the edible straw S is being carried.

The above description is intended to provide a specific explanation on the present invention and the scope of the present invention is not to be limited to the examples. Various modes without departing from the gist of the present invention are encompassed by the present invention, and, for example, parts of the embodiments described above may appropriately be combined.
100 . . . edible sheet, 101 . . . sealing member, 200 . . . mandrel, 300 . . . powder, 400 . . . container box, S . . . edible straw

1. A method for manufacturing an edible straw, comprising the steps of:
applying an edible adhesive on at least one surface of a rice paper to soften the rice paper;
forming the rice paper on which the adhesive is applied into a tubular body such that the adhesive is present between overlapped portions of the rice paper; and
heating the tubular body from at least one of an inner wall side and an outer wall side of the tubular body to allow a water content of the adhesive to evaporate.

2. The method for manufacturing an edible straw according to claim 1, wherein in the step of forming into a tubular body, the tubular body is formed by wrapping the rice paper on which the adhesive is applied around a mandrel, the mandrel being a radiator formed in a cylindrical shape, and
in the step of heating, heating is started on the inner wall side of the tubular body by the mandrel, and after the tubular body is expanded, heating is started on the outer wall side of the tubular body.

3. The method for manufacturing an edible straw according to claim 1, further comprising:
filling a space surrounded by the inner wall of the tubular body with powder.

4. The method for manufacturing an edible straw according to claim 3, further comprising:
sealing one opening of the tubular body to form a bottomed tubular body;
feeding the powder from another opening of the bottomed tubular body; and
sealing the other opening of the bottomed tubular body.

5. The method for manufacturing an edible straw according to claim 1, wherein
a specified number of the tubular bodies are contained in a container configured to be capable of containing a plurality of the edible straws, and a space surrounded by the inner wall of each of the tubular bodies and any space in the container other than the space surrounded by the inner wall of each of the tubular bodies are filled with powder.

6-9. (canceled)

10. The method for manufacturing an edible straw according to claim 2, further comprising:
filling a space surrounded by the inner wall of the tubular body with powder.
